(19) United States
(12) Patent Application Publication
(10) Pub. No.: US 2025/0369389 A1
(43) Pub. Date: Dec. 4, 2025

(54) TURBINE-GENERATOR, POWER PLANT AND METHOD

(71) Applicant: Aker Solutions AS, Lysaker (NO)

(72) Inventors: KJELL OLAV STINESSEN, OSLO (NO); GEIR INGE OLSEN, OSLO (NO)

(73) Assignee: Aker Solutions AS, Lysaker (NO)

(21) Appl. No.: 18/874,096

(22) PCT Filed: Jun. 12, 2023
(86) PCT No.: PCT/NO2023/050134

§ 371 Date: Dec. 12, 2024

(30) Foreign Application Priority Data
Jun. 13, 2022 (GB) 2208574.0

(51) Int. Cl. F02C 1/10; F02C 7/12; F02C 7/36

(52) U.S. Cl. CPC F02C 1/10; F02C 7/12; F02C 7/36; F05D 2220/76; F05D 2260/213

(57) ABSTRACT

A fluid turbine-generator includes a pressure housing, a turbine having a fluid inlet and a fluid outlet, an electric generator, and a shaft which mechanically connects the turbine and the electric generator. The fluid inlet is connected to the turbine and is arranged to extend into the pressure housing. The fluid outlet is connected to the turbine and is arranged to extend out of the pressure housing. The turbine and the electric generator are each arranged inside the pressure housing. The shaft is arranged completely inside the pressure housing.

### CROSS REFERENCE TO PRIOR APPLICATIONS

This application is a U.S. National Phase application under 35 U.S.C. § 371 of International Application No. PCT/NO2023/050134, filed on Jun. 12, 2023 and which claims benefit to Great British Patent Application No. 2208574.0, filed on Jun. 13, 2022. The International Application was published in English on Dec. 21, 2023 as WO 2023/244119 A1 under PCT Article 21(2).

### FIELD

The present invention relates to a turbine-generator, to a power plant comprising a turbine-generator, and to a method for producing electric power.

### BACKGROUND

Turbine-generators are used for a variety of power generation applications, such as Rankine cycle engines and Joule/Brayton cycle engines. Power plants employing turbine-generators can be used with a variety of heat sources, and a range of different plant designs and turbine-generator designs exist for the purpose of converting heat energy to electric power. Examples of turbine-generators for some applications are described in EP 0 462 724 A1, EP 3 405 676 B1, WO 2018/063820 A1, and U.S. Pat. No. 9,024,460 B2.

One application of a power plant utilizing a turbine-generator is described in WO 2015/173184 A1, showing a method for generation of power with CO₂ capture, where electrical power is produced from combustion at elevated pressure and operation of a turbine-generator in a heat engine. The power plant is located offshore, where requirements such as compactness, weight, reliability and/or maintenance requirements may be of particular importance. Other (offshore and/or land-based) applications may also have similar or the same design requirements.

A need exists for improved technology relating to turbine-generators and power plants for efficient power generation.

### SUMMARY

An aspect of the present invention is to provide such improvements, or at least useful alternatives to known technology.

In an embodiment, the present invention provides a fluid turbine-generator which includes a pressure housing, a turbine comprising a fluid inlet and a fluid outlet, an electric generator, and a shaft which is configured to mechanically connect the turbine and the electric generator. The fluid inlet is connected to the turbine and is arranged to extend into the pressure housing. The fluid outlet is connected to the turbine and is arranged to extend out of the pressure housing. The turbine and the electric generator are each arranged inside the pressure housing. The shaft is arranged completely inside the pressure housing.

### BRIEF DESCRIPTION OF THE DRAWINGS

The present invention is described in greater detail below on the basis of embodiments and of the drawings in which:

FIG. 1 is a schematic view of a power plant having a turbine-generator;

FIG. 2 is a schematic view of a turbine-generator according to an embodiment;

FIG. 3 illustrates an example of a power plant;

FIG. 4 illustrates another example of a turbine-generator;

FIG. 5 illustrates a turbine-generator having fluid lubricated bearings;

FIG. 6 illustrates a turbine-generator having a cooling system;

FIG. 7 is a schematic view of a turbine-generator according to an embodiment;

FIG. 8 is a schematic view of a turbine-generator according to an embodiment;

FIG. 9 illustrates a first alternative design for the cooling of a turbine and/or an electric generator in a power plant; and

FIG. 10 illustrates a second alternative design for the cooling of a turbine and/or an electric generator in a power plant.

### DETAILED DESCRIPTION

The present invention provides a fluid turbine-generator, the turbine-generator comprising: a pressure housing, a turbine having a fluid inlet and a fluid outlet connected thereto and extending into and out of the pressure housing, and an electric generator, wherein the turbine and the electric generator are arranged inside the pressure housing.

The present invention provides a power plant comprising a fluid turbine-generator, a flow loop operatively connected to the inlet and outlet, and comprising a first heat exchanger configured to heat a working fluid circulating in the flow loop, a pump and a second heat exchanger configured to cool the working fluid circulating in the flow loop.

The present invention provides a method of producing electric power, the method comprising operating a power plant, the plant being arranged on a sea floor or on an offshore platform, receiving, at the fuel inlet, a carbonaceous fuel extracted from an offshore hydrocarbon well, providing a reactant at a reactant inlet, the reactant inlet being provided from a land-based location, from the offshore platform, or from a tank arranged at the sea floor, and pumping flue gas from the reactor to an underground formation.

The detailed description below and appended claims outline further embodiments of the present invention. These and other characteristics will become clear from the following description of illustrative embodiments, given as non-restrictive examples, with reference to the attached drawings.

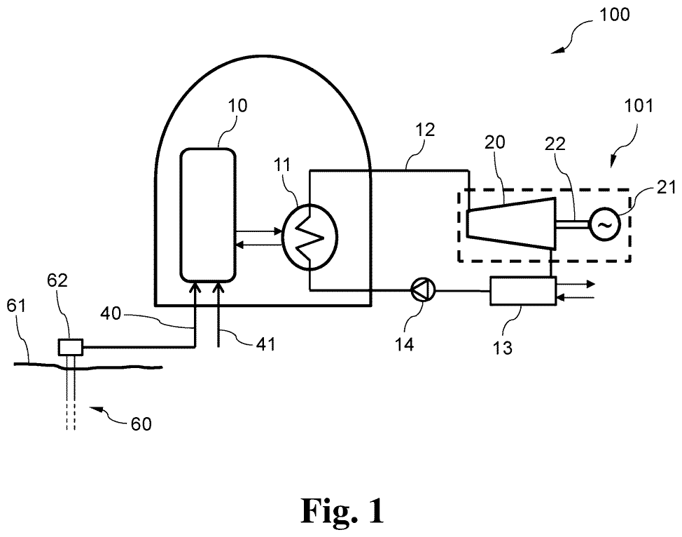

FIG. 1 shows a power plant 100 according to a schematically illustrated embodiment. The power plant 100 has a reactor 10, such as a combustion chamber, exchanging heat with a heat exchanger 11, for example, via a circulating liquid. A flow loop 12 having a working fluid is also connected to the heat exchanger 11. The flow loop 12 may optionally extend directly into the reactor 10 and have a heat exchanger arranged in the reactor 10 for transfer of heat to the working fluid.

The reactor 10 receives a fuel (for example, a hydrocarbon fuel) via a fuel line 40 and a reactant (for example, oxygen or an oxygen-containing gas) via a reactant line 41. The fuel may, for example, be provided from a hydrocarbon well 60, such as a petroleum well. The hydrocarbon well 60 can be a subsea well having a wellhead 62 which is arranged at or directly adjacent the sea floor 61. This configuration can be particularly advantageous if the power plant 100 is arranged on the sea floor 61 or on an offshore platform directly above the sea floor 61. The fuel line 40 can provide a fluid connection between the hydrocarbon well 60 and the reactor 10 for provision of hydrocarbon fuels in such a configuration. Although FIG. 1 shows such a connection schematically as a direct connection between the wellhead 62, the skilled reader will understand that various equipment may be arranged in the connection, such as pressure control equipment or processing equipment. The fluid connection can be continuous, i.e., provide a direct connection between the hydrocarbon well 60 and the reactor 10 (save for valves etc. arranged in the flow path). Advantageously, the fuel is or contains a hydrocarbon gas, such as methane.

The working fluid in the flow loop 12 may, for example, be water, an organic fluid (such as a hydrofluorocarbon) or CO₂. The working fluid is heated in the heat exchanger 11 and circulates to a turbine-generator 101 in which it is expanded in a turbine 20. The turbine 20 is operatively connected to an electric generator 21 via a shaft 22 to produce electric power. The expanded working fluid is further circulated from the turbine 20 to a cooling heat exchanger 13 and a pump 14, and back to the heat exchanger 11. The skilled reader will recognize the illustrated cycle as being a Rankine-type setup. In alternative embodiments, the turbine-generator 101 can receive working media from a different source, for example, from a gas turbine combustor.

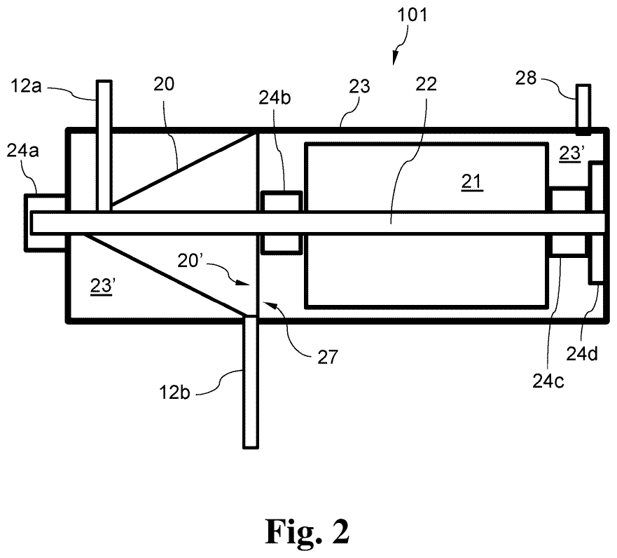

FIG. 2 illustrates the turbine-generator 101 consisting of the turbine 20 and the electric generator 21 integrated in a common pressure housing 23. An inlet 12a provides heated and pressurized working media to the turbine 20, and an outlet 12b leads the working media from the turbine 20 and out of the pressure housing 23. In a plant arrangement such as that shown in FIG. 1, the inlet 12a and outlet 12b are part of the flow loop 12, and the outlet 12b is fluidly connected to the cooling heat exchanger 13.

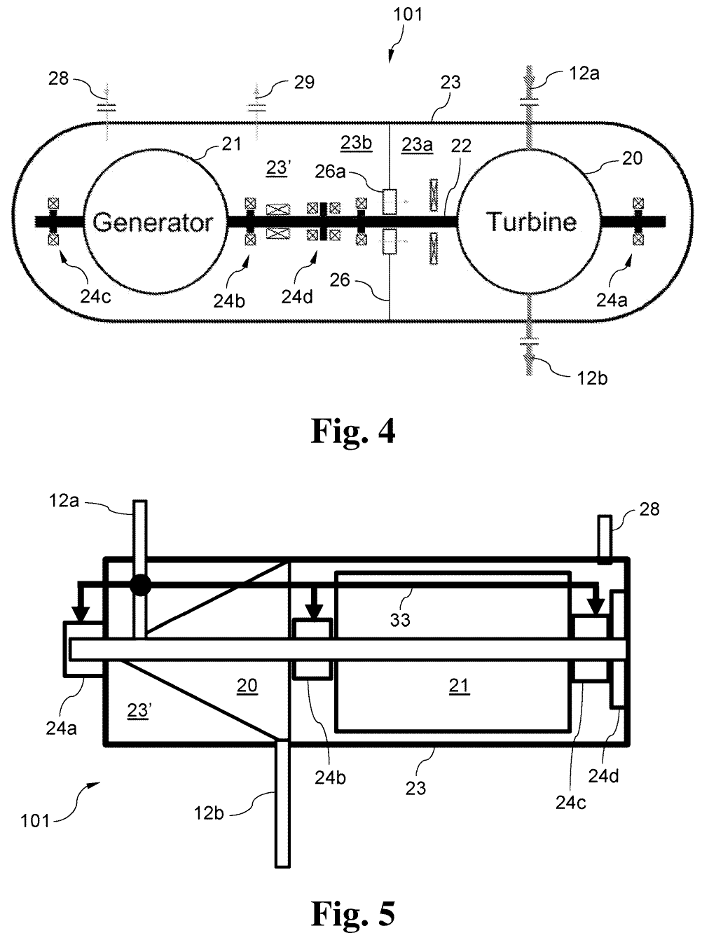

The turbine 20 and the electric generator 21 occupy different parts of the interior volume 23′ of the pressure housing 23, which may be arranged as separate turbine and generator compartments, described in relation to FIG. 4 below.

The pressure housing 23 is sealed towards the ambient, which can, for example, be sea water at a subsea location. The turbine 20 and the electric generator 21 are both arranged fully inside the pressure housing 23.

The turbine 20 and the electric generator 21 may advantageously be connected via the shaft 22 so that the turbine 20 and the electric generator 21 are longitudinally spaced along the shaft 22.

The shaft 22 may be a single shaft to which both the turbine 20 and the electric generator 21 are connected, or it may be two or more shaft parts which are connected together (for example, bolted together) to form a common shaft.

The turbine-generator 101 further comprises bearings 24a-d supporting the shaft 22 in the pressure housing 23. The bearings 24a-d in this embodiment comprises three radial bearings 24a-c and one axial (thrust) bearing 24d. The turbine-generator 101 may comprise fewer or more bearings, for example, two radial bearings and two thrust bearings. The positioning of the bearings 24a-d can be at any suitable place along the shaft 22 and inside the pressure housing 23. The bearings 24a-d may be arranged as an integral part of the pressure housing 23, or they may be formed by separate parts which are fixed to the pressure housing 23 at an inside of the pressure housing 23. The turbine 20, the electric generator 21, and the shaft 22 are advantageously arranged fully inside the pressure housing 23 so that the shaft 22 does not penetrate the pressure housing 23, i.e., whereby no sealing is required between the pressure housing 23 and (a part of) the shaft 22 to an outside of the pressure housing 23. The bearings 24a-d can, for example, be magnetic bearings, but can alternatively be liquid or gas bearings. The bearings 24a-d can advantageously be lubricated with the working fluid.

The entire interior volume 23′ of the pressure housing 23 can advantageously be configured to be filled with a fluid which is the same fluid as supplied to the turbine 20 via the inlet 12a (for example, water vapor or CO₂). The interior volume 23′ can be filled with the fluid at a pressure which is substantially equal to or equal to a pressure at the outlet 12b. For this purpose, a fluid opening or fluid connection may be provided from the low-pressure end 20′ of the turbine 20 and/or from the outlet 12b into the interior volume 23′. The opening or fluid connection is not illustrated in the drawings, but may be in the form of a slot, opening, pipe, duct or equivalent. The interior volume 23′ is thereby filled with the working fluid of the plant, whereby sealing requirements between components and/or compartments inside the pressure housing 23 can be relaxed and the consequences of leakages of working fluid into the interior volume 23′ are less severe.

The interior volume 23′ can be arranged so that there are no internal, fluid-tight partitions inside the pressure housing 23. All the components inside the pressure housing 23, hereunder the electric generator 21, thereby operate in the same environment. Separate or partially separate turbine and generator compartments may alternatively be used, as described in relation to FIG. 4 below.

The pressure housing 23 is configured to withstand the pressure difference between the interior volume 23′ and the ambient, i.e., the conditions outside the pressure housing 23. If used under water, the ambient may involve an external pressure considerably higher than standard atmospheric pressure. The external pressure may, for example, be about 100 bara if the turbine-generator 101 is installed at 1000 m water depth, it may, however, also only be atmospheric pressure (ca. 1 bara) if installed on a platform or on land.

In a power plant employing a turbine-generator 101 as described herein, the working fluid can be water and the power plant 100 can be configured to evaporate the water in heat exchanger 11 and to condense the water in cooling heat exchanger 13.

The working fluid can alternatively be CO₂. The power plant 100 can in such a case be configured to operate with the CO₂ in a supercritical state in the entire cycle, i.e., at any point in the flow loop 12. The CO₂ downstream of the turbine 20 can be condensed to liquid or to a partially liquid state.

The pump 14 can be a liquid pump, a multiphase pump, a fan, or a compressor, depending on the choice of working fluid in the power plant 100.

In an embodiment, the power plant 100 is configured to operate with a pressure at the outlet 12b which is less than 1 bara, less than 0.5 bara, or less than 0.2 bara. This may, for example, be advantageous if the working fluid is water.

In an embodiment, the power plant 100 is configured to operate with a pressure at the outlet 12b which is higher than 5 bara, higher than 10 bara, or higher than 25 bara. This may, for example, be advantageous if the working fluid is CO₂ and in particular if the plant is configured so that the CO₂ remains in a supercritical state throughout the cycle. Configuring the power plant 100 to have a pressure at the outlet 12b which is higher than 5, 10 or 25 bara while having the pressure housing 23 arranged so that the pressure in the interior volume 23′ is substantially the same as the pressure at the outlet 12b, may advantageously reduce the pressure difference between the inside and outside of the pressure housing 23 if using the power plant 100 subsea.

FIG. 2 also shows that the turbine-generator 101 may comprise a cooling medium inlet 28 which extends through the pressure housing 23 and into the interior volume 23′. The cooling medium may thereby be circulated past the electric generator 21 and, if applicable, other components in the pressure housing 23 which require cooling. An outlet for the cooling medium may be provided via the outlet 12b, for example, via fluid openings or passages inside the pressure housing 23 (for example, at or near a location 27 which is close the outlet 12b) through which the cooling medium can flow from the interior volume 23′ and into the outlet 12b. The cooling medium thereby mixes with the working fluid downstream of the turbine 20 and is removed from the pressure housing 23.

The pressure housing 23 can alternatively have a dedicated cooling medium outlet 29, which is illustrated in relation to FIG. 4 and described below, for the cooling medium.

In any of the embodiments described herein, the cooling medium may advantageously be the same fluid as the working fluid, for example, water or CO₂.

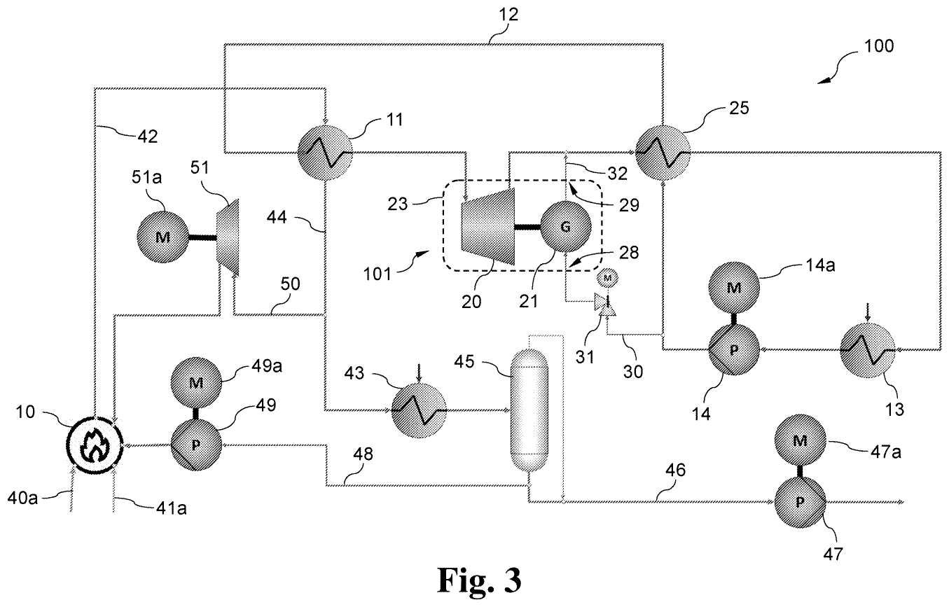

FIG. 3 illustrates a power plant 100 having some of the same components as those described above, which are given the same reference numerals. A pump 14 drives a working fluid in a flow loop 12 so that the working fluid is pumped through a heat exchanger 11 to be heated. The heated working fluid is led to a turbine 20 which is connected to an electric generator 21 to produce electric power by expansion of the working fluid. The turbine-generator 101 may be a fluid turbine-generator as described elsewhere herein.

The working fluid downstream of the turbine 20 is led through a cooling heat exchanger 13 before being led to the pump 14. In any of the embodiments described herein, the cooling heat exchanger 13 may be provided with cooling water from the sea. This can allow for the working fluid to be cooled down to a temperature of, for example, below 20° C., or below 10° C.

A recuperating heat exchanger 25 is optionally arranged for heat exchange between the working fluid when downstream of the pump 14 and upstream of the heat exchanger 11, and when downstream of the turbine 20 and upstream of the cooling heat exchanger 13. This provides for a pre-heating of the working fluid provided by the pump 14 before the working fluid is led into the heat exchanger 11.

In an embodiment, a cooling medium supply pipe 30 extends from the flow loop 12 and into the pressure housing 23 via the cooling medium inlet 28. A cooling medium can thereby be provided in the form of working fluid from the cycle. The cooling medium supply pipe 30 advantageously provides a slip stream taken out downstream of the cooling heat exchanger 13 and upstream the recuperating heat exchanger 25 and the heat exchanger 11. Cooling medium of low temperature can thereby be provided to the pressure housing 23.

The cooling medium supply pipe 30 may advantageously extend from the flow loop 12 downstream of the pump 14 and into the pressure housing 23 via the cooling medium inlet 28. A flow of cooling medium can thereby be driven by the pump 14 and no dedicated cooling medium pump may be needed. The cooling medium supply pipe 30 may alternatively connect to a different location at the flow loop 12 and/or a dedicated cooling medium pump (not shown here) may be provided in the cooling medium supply pipe 30.

The cooling medium supply pipe 30 may have a regulation valve 31 to control the flow of cooling medium into the pressure housing 23.

As described above, the pressure housing 23 can be configured to discharge cooling medium out of the pressure housing 23 and into the flow loop 12 via the outlet 12b together with the working fluid.

As illustrated in FIG. 3, a cooling medium discharge pipe 32 can alternatively extend from the cooling medium outlet 29 and into the flow loop 12. The cooling medium discharge pipe 32 can, for example, be connected to the flow loop 12 downstream of the turbine 20 and upstream of the pump 14. The cooling medium from the pressure housing 23 is thereby discharged into the flow loop at the low-pressure side thereof.

A bleed-off lubrication fluid line 33 (described in relation to FIG. 5 below) may be provided in the same way as cooling medium supply pipe 30, or the cooling medium supply pipe 30 may provide both the cooling and the lubrication medium to the turbine-generator 101. A lubrication fluid line may thereby provide fluid for lubrication of fluid-lubricated bearings in the turbine-generator 101 (e.g., bearings 24a-d), and in particular provide such a lubrication fluid at a suitable flow rate, pressure, and temperature. A regulation valve (similar to regulation valve 31) may be used to regulate the flow of lubrication medium to the turbine-generator 101. Lubrication fluid having passed across or through the bearings can be allowed to exit into the interior volume 23′, and to flow out of the housing 23 via the outlet 12b, via a cooling medium outlet 29, or via a different means. By using fluid from the flow loop 12 for lubrication, the fluid can advantageously be passed across or through the bearings and simply be allowed to exit into the interior volume 23′ without negatively impacting the turbine-generator 101.

FIG. 3 further illustrates the reactor 10, which in this embodiment is a combustion chamber having a fuel inlet 40a for fuel and a reactant inlet 41a for a reactant. The fuel may, for example, be a hydrocarbon gas and the reactant may be oxygen or a gas mixture comprising oxygen. A reactor outlet line 42 leads a hot combustion gas mixture to the heat exchanger 11 for exchange of heat with the working fluid in the flow loop 12. The combustion gas mixture comprises combustion gases from the reaction between the fuel and reactant, and an amount of recycled fluid (described in further detail below).

The combustion (flue) gas mixture is led to a cooler 43 via line 44 downstream of the heat exchanger 11. The cooler 43 may, for example, be a seawater cooler. A collection vessel 45 can be arranged to receive the combustion gas mixture downstream of the cooler 43.

From the collection vessel 45, a deposit line 46 having a deposit pump 47 is arranged to remove combustion products, for example, to deposit combustion products in a subterranean reservoir. If the fuel is a hydrocarbon gas and the reactant is substantially pure oxygen, then the combustion products will consist predominantly of CO₂ and H₂O.

A first recycle line 48 is provided, having a pump 49 with motor 49a, and through which cooled combustion products can be recycled into the reactor 10. The first recycle line 48 is fluidly connected downstream of the collection vessel 45. The power plant 100 may additionally or alternatively comprise a second recycle line 50 having a pump 51 which is driven by a motor 51a for recycling combustion gases into the reactor 10. Such an exhaust gas recirculation can be provided to control the temperatures of the fluid in the reactor 10 and/or in the reactor outlet line 42 and the heat exchanger 11. Fluid from one or both the recycle line(s) 48 and/or 50 may also be led to other parts of the reactor 10, for example, to cool structural parts of a combustion chamber or associated components.

The power plant 100 may be arranged so that the first recycle line 48 operates to recycle cooled flue gas into structural cooling channels in the reactor 10, and the second recycle line 50 operates to recycle flue gas into a combustion chamber in the reactor 10. The cooling channels may, for example, be pipes, duct, bores or the like, whereby the cooled flue gas can be passed along structural parts of the reactor 10, such as combustion chamber walls or other structural components, before being led into the combustion chamber or the reactor outlet line 42. The second recycle line 50 can be arranged to recycle cooled flue gas into the combustion chamber of the reactor 10, i.e., into the reaction zone. Enhanced control of the cooling can thereby be achieved in that the reaction zone (e.g., flame) temperature and the temperature of the structural parts can be controlled more independently.

The fuel inlet 40a is advantageously connected to a fuel line 40 (see FIG. 1) which is in fluid connection with a hydrocarbon well 60, in particular with an offshore hydrocarbon well. The hydrocarbon well 60 may be a petroleum well in any of the embodiments described herein. Such an offshore hydrocarbon well may be a subsea well, having a wellhead 62 arranged at or directly adjacent the sea floor 61, or it may be an offshore well extending via a riser to an offshore platform (a so-called “dry wellhead”). The power plant 100 may in either case be positioned on the sea floor 61 or on an offshore platform.

The fuel line 40 may be arranged to provide the fuel at a pressure which is the same or substantially the same as the pressure at the wellhead 62. The fuel line 40 may for this purpose contain no pressure-increasing equipment (such as pumps or compressors) if the pressure at the wellhead 62 is sufficiently high. The fuel line 40 may have pressure control equipment (such as valves) and/or pressure reduction equipment (such as throttles) in order to control the pressure of the fuel delivered to the reactor 10. The pressure of the fuel delivered to the reactor 10 may be lower than the pressure at the wellhead 62.

In cases where the wellhead pressure is too low to achieve the desired pressure in the reactor 10 and/or density of the exhaust gas in the deposit line 46 for injection, a compressor, multiphase pump or pump can be installed in the fuel line 40 to increase the pressure. This may extend the operational area of the power plant 100 to allow use of lower pressure hydrocarbon gas, such as supplies from wells in a late stage of the production life. Other low pressure fuels can also alternatively or additionally be used in this way.

In any of the embodiments described herein, the power plant 100 may advantageously be arranged so that the fuel pressure from the hydrocarbon well 60 maintains a fuel delivery pressure at the fuel inlet 40a which is higher than 20 bara, higher than 30 bara, or higher than 40 bara.

One or more, or, for example, all, the motors 14a, 47a, 49a and 51a associated with the pumps 14, 47, 49 and/or 51 may advantageously be powered by a part of the energy produced by the electric generator 21.

The pumps 14, 47, 49 and 51 may be of the type most suitable according to the state of the fluid to be pumped, and may, for example, be a compressor or a centrifugal pump.

Surplus electric power generated by the electric generator 21 may, for example, be provided by cable to a land-based grid, or to consumers offshore such as petroleum installations.

FIG. 4 illustrates another embodiment of a turbine-generator 101 with a similar design as that shown in FIG. 2 and where the same reference numerals are used for corresponding components.

The embodiment shown in FIG. 4 comprises a cooling medium inlet 28 extending through the pressure housing 23 and into the interior volume 23′, and a cooling medium outlet 29 extending through the pressure housing 23 and out of the interior volume 23′. The cooling medium inlet 28 and cooling medium outlet 29 may, for example, be pipes welded or otherwise integrated with the pressure housing and having a flange or connector to which further piping (e.g., cooling medium supply pipe 30 and cooling medium discharge pipe 32 as described above) can be connected. A cooling medium can be circulated through the interior volume 23′ via this arrangement in order to control the working temperature(s) of the generator and/or other components of the turbine-generator 101.

FIG. 4 also shows that the turbine 20 and the electric generator 21 may occupy different parts of the interior volume 23′ of the common pressure housing 23, which may be arranged as separate turbine and generator compartments 23a and 23b. The turbine and generator compartments 23a and 23b may be separated by a division 26, such as a wall or a plate. The division 26 can be sealingly arranged inside the pressure housing 23 to separate the turbine and generator compartments 23a and 23b, with a seal 26a towards the shaft 22. The seal 26a may, for example, be a labyrinth seal. In some embodiments, for example, where the cooling medium is the same as the working fluid, the sealing requirements for the seal 26a may be somewhat relaxed in that some leakage across the seal 26a may be tolerated.

FIG. 5 schematically shows that the turbine-generator 101 may comprise a bleed-off lubrication fluid line 33 which is fluidly connected to the inlet 12a and which is configured to route a stream of the working fluid to the bearing(s) 24a-d for lubrication. A slip stream of working fluid can be utilized in this manner for lubrication purposes by routing it to the fluid lubricated bearings. Alternative to taking such lubrication fluid off the inlet 12a, it may be taken out from the turbine 20 upstream the low-pressure end 20′, i.e., by bleeding off pressurized working fluid from an intermediate stage of the turbine 20 and by routing this fluid to the fluid lubricated bearings. The latter option may, for example, be suitable if the state of the working fluid is more beneficial (for example, in relation to pressure and/or temperature) at an intermediate stage of the turbine 20 than at the inlet 12a, or if this is structurally more convenient to arrange with lubrication fluid passages, for example, within the pressure housing 23 for this purpose. In another alternative, the bleed-off lubrication fluid line 33 may be connected to the cooling medium inlet 28 or to a dedicated lubrication fluid pipe extending into the housing 23 for this purpose.

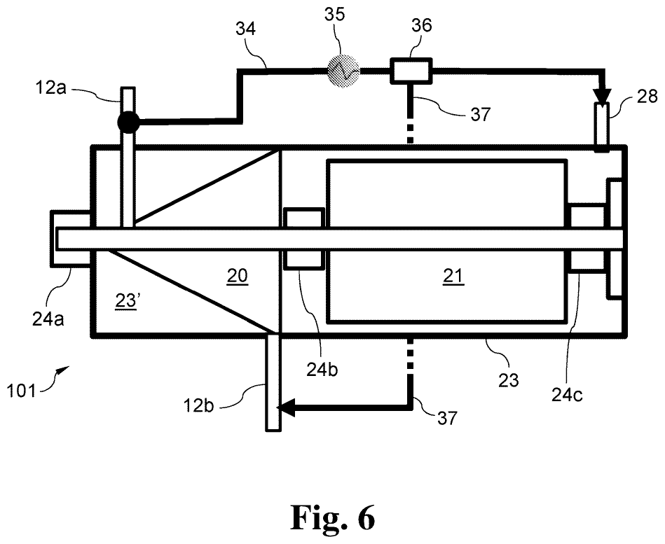

FIG. 6 shows that the turbine-generator 101 may alternatively or additionally comprise a bleed-off cooling fluid line 34 which is fluidly connected to the inlet 12a and which is configured to route a stream of the working fluid to the cooling medium inlet 28 via a cooling fluid heat exchanger 35. The cooling fluid heat exchanger 35 may, for example, be cooled sea water. Alternative to taking such cooling medium off the inlet 12a, it may be taken out from the turbine 20 upstream the low-pressure end 20′, i.e., by bleeding off pressurized working fluid from an intermediate stage of the turbine 20 and by routing this fluid to the cooling fluid heat exchanger 35 and to the cooling medium inlet 28. The latter option may, for example, be suitable if the state of the working fluid is more beneficial (for example, in relation to pressure and/or temperature) at an intermediate stage of the turbine 20 than at the inlet 12a, or if this is structurally more convenient to arrange with cooling medium passages within the pressure housing 23 for this purpose.

A liquid separator 36 can be arranged downstream of the cooling fluid heat exchanger 35 in order to separate out liquid components of the working fluid bled off from the inlet 12a (or turbine 20) before it is routed to the cooling medium inlet 28 and into the interior volume 23′. A cleaner and dryer cooling medium can thereby be provided to the cooling medium inlet 28. As described above, the cooling medium may be arranged to exit the interior volume 23′ via a dedicated cooling medium outlet 29 (see FIG. 4), or by allowing it to enter the working medium flow at or downstream of the outlet 12b.

The liquid separator 36 can be connected to and configured to discharge liquid separated out of the slip stream taken off the inlet 12a into the outlet 12b or into the flow loop 12 downstream of the outlet 12b.

In this embodiment, a cooling of the electric generator 21 can thus be achieved by taking bleed off fluid from a stage of the turbine 20 with a higher pressure than the last stage or from the inlet 12a and by routing the bleed fluid via the cooling fluid heat exchanger 35 and thereafter injecting it into the generator compartment 23b or into the interior volume 23′ for cooling the electric generator 21.

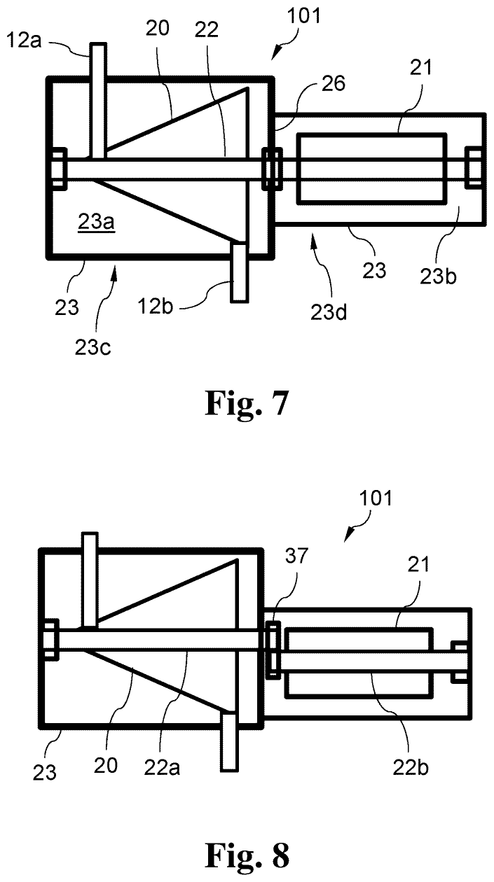

FIG. 7 illustrates another embodiment which is suitable for use in conjunction with any of the embodiments described herein in which the pressure housing 23 is made up of two parts 23c and 23d having a different size in a plane perpendicular to the longitudinal axis if the shaft 22 (e.g., a different diameter or a different height/width.) The interface between the parts 23c,d can make up the division 26, through which a throughbore or other opening is provided for the shaft 22. Separate generator compartments 23a,b can thereby be provided similar to that described in relation to FIG. 4 above. The parts 23c,d may, for example, be bolted or welded together so as to form a common pressure housing 23. This configuration may be beneficial if the electric generator 21 has a smaller diameter than the turbine 20.

FIG. 8 illustrates another embodiment which is suitable for use in conjunction with any of the embodiments described herein in which the turbine 20 comprises a first shaft part 22a and the electric generator 21 comprises a second shaft part 22b, and the first shaft part 22a and the second shaft part 22b are interconnected via a gear 37. The gear 37 may be arranged so that the rotational speed of the electric generator 21 is lower than that of the turbine 20, for example, so that the generator speed is half that of the turbine 20. This can provide additional design and/or operational flexibility of the turbine-generator 101.

The housing 23 may in this embodiment be made up of a first part 23c and a second part 23d as described above in relation to FIG. 7, or the housing 23 may be of a design as illustrated in FIG. 2 or 4. The first shaft part 22a, the second shaft part 22b, and the gear 37 are advantageously arranged fully inside the pressure housing 23.

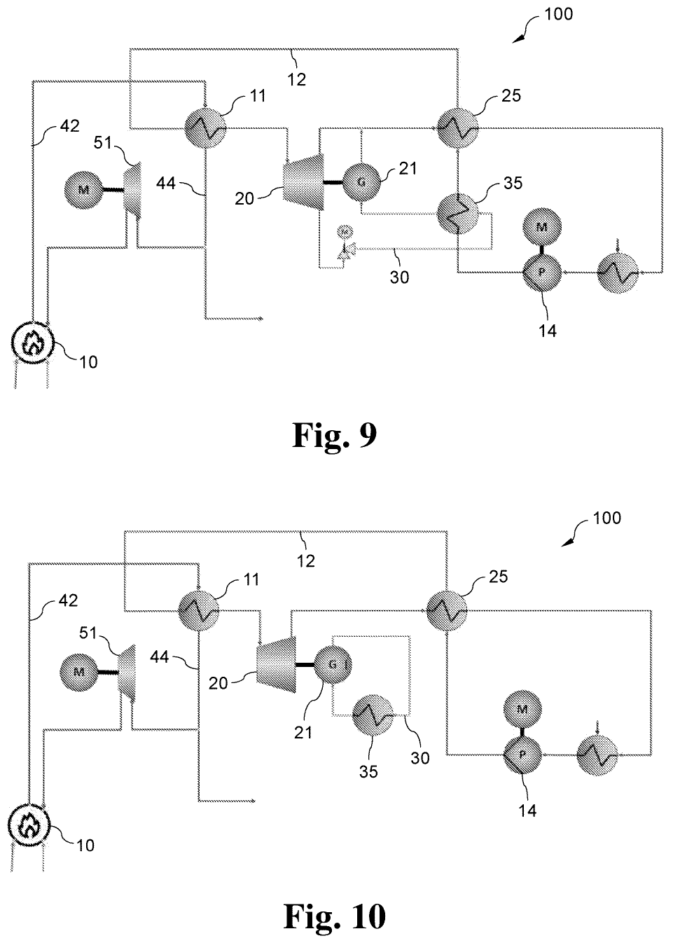

FIGS. 9 and 10 illustrate alternative embodiments for the cooling of the turbine 20 and/or the electric generator 21. Various features of the power plant 100 in FIGS. 9 and 10 are similar to those described above in relation to FIG. 3 and will not here be repeated.

In FIG. 9, the cooling medium supply pipe 30 extends from the turbine 20 (for example, from an intermediate stage of the turbine 20 or an outlet of the turbine 20) and via a cooling fluid heat exchanger 35 which is external to the pressure housing 23. From the cooling fluid heat exchanger 35, the cooling fluid is provided to the electric generator 21 and/or turbine 20 (for example, via a cooling medium inlet 28) and thereafter back into the flow loop 12. The cooling fluid heat exchanger 35 is arranged in the flow loop 12 downstream of the pump 14 and upstream of the heat exchanger 11 (and, if used, recuperating heat exchanger 25) in the shown embodiment. The cooling fluid heat exchanger 35 may alternatively be arranged to exchange heat with ambient fluid, such as ambient sea water.

In FIG. 10, the cooling medium supply pipe 30 forms a dedicated cooling loop via which cooling fluid is circulated through the pressure housing 23 (for example, via cooling medium inlet 28 and cooling medium outlet 29). A dedicated cooling media pump (not illustrated) can be provided for this purpose to provide forced circulation through the cooling loop. The cooling fluid heat exchanger 35 is external to the pressure housing 23 and may, for example, be a heat exchanger arranged to exchange heat with ambient fluid, such as ambient sea water. The cooling fluid heat exchanger 35 may alternatively be arranged to exchange heat with fluid in the flow loop 12, for example, similarly as illustrated in FIG. 9.

The cooling arrangement as shown in FIG. 9 and/or FIG. 10 may be used in conjunction with any suitable embodiment described herein.

The power plant 100 can be installed and operated subsea, but can also be used topside on platforms, or onshore. For an example installation, reference is made to the abovementioned WO 2015/173184 A1.

Generally, if oxyfuel is used to burn carbonaceous fuels, the exhaust will mostly consist of H₂O and CO₂, possibly with contaminants like nitrogen, argon, oxygen and carbon monoxide. The content of contaminants may determine the pressure and temperature level that is needed to completely condense the CO₂, meaning that a content of contaminants may require a higher pressure or a lower temperature, or a combination of both. It is not, however, required that all CO₂ be condensed or that supercritical CO₂ be formed to allow pumping. Even with a high gas volume fraction (GVF), the multiphase mix of condensate can be pumpable by using either a gas tolerant liquid pump, a multiphase pump, or a wet-gas compressor. By selecting such a device, the requirement of the partly condensed exhaust can be as low as 300 kg/m³ or even lower, and it will still be pumpable down into an underground formation for storage. That underground formation could be back to the reservoir that the gas is being produced from, an aquifer, or another formation.

The power plant 100 may have a supply of oxygen, oxygen-enriched air, or another reactant provided via one or more pipes from e.g., an air separation plant on a floating or fixed platform. It could also be supplied via a pipeline from shore. A reactant could alternatively be stored and be supplied to the power plant 100 from tanks located at the seabed or on a platform or vessel. The storage tanks could also be a reactant supplied by a ship.

Further inventive aspects and embodiments according to the present disclosure are listed in the following numbered clauses.

Clause 1: A fluid turbine-generator (101), the turbine-generator (101) comprising:
a pressure housing (23); and
a turbine (20) having a fluid inlet (12a) and a fluid outlet (12b) connected thereto and extending into and out of the pressure housing (23);
an electric generator (21);
wherein the turbine (20) and the electric generator (21) are arranged inside the pressure housing (23).

Clause 2: The fluid turbine-generator (101) of clause 1, comprising a common shaft (22) mechanically connecting the turbine (20) and the electric generator (21), wherein the turbine (20) and the electric generator (21) are longitudinally spaced along the common shaft (22).

Clause 3: The fluid turbine-generator (101) of any preceding clause, wherein the common shaft (22) is arranged fully inside the pressure housing (23).

Clause 4: The fluid turbine-generator (101) of any preceding clause, wherein the turbine (20) comprises a first shaft part (22a) and the electric generator (21) comprises a second shaft part (22b), and wherein the first and second shaft parts (22a,b) are interconnected via a gear (37).

Clause 5: The fluid turbine-generator (101) of any preceding clause, wherein the first and second shaft parts (22a,b) and the gear (37) are arranged fully inside the pressure housing (23).

Clause 6: The fluid turbine-generator (101) of any preceding clause, wherein a generator compartment (23b) and/or the entire interior volume (23′) of the pressure housing (23) is configured to be filled with a fluid which is the same fluid as supplied to the turbine (20) via the inlet (12a).

Clause 7: The fluid turbine-generator (101) of the preceding clause, wherein the entire interior volume (23′) of the pressure housing (23) is configured to be filled with the fluid at a pressure which is substantially equal to or equal to a pressure at the outlet (12b).

Clause 8: The fluid turbine-generator (101) of any preceding clause, comprising an fluid opening from a low-pressure end (20′) of the turbine (20) and/or from the outlet (12b) and into the entire interior volume (23′).

Clause 9: The fluid turbine-generator (101) of any preceding clause, wherein the entire interior volume (23′) is separated into turbine and generator compartments (23a,b) by a division (26).

Clause 10: The fluid turbine-generator (101) of any preceding clause, wherein the division (26) comprises a seal (26a) towards the shaft (22).

Clause 11: The fluid turbine-generator (101) of any preceding clause, wherein the entire interior volume (23′) comprises no internal, fluid-tight partitions inside the pressure housing 23.

Clause 12: The fluid turbine-generator (101) of any preceding clause comprising a plurality of bearings (24a-d) arranged to support the shaft (22).

Clause 13: The fluid turbine-generator (101) of any preceding clause, wherein the bearings (24a-d) are magnetic bearings.

Clause 14: The fluid turbine-generator (101) of any preceding clause, wherein the bearings are fluid lubricated bearings configured to be lubricated with the same fluid as is supplied to the turbine (20) via the inlet (12a).

Clause 15: The fluid turbine-generator (101) of the preceding clause, comprising a bleed-off lubrication fluid line (33) fluidly connected to the flow loop (12), to the cooling medium inlet (28), to a dedicated lubrication line extending through the housing (23), to the inlet (12a) and/or to the turbine (20) upstream the low-pressure end (20′) and configured to route a stream of the fluid to the bearing(s) (24a-d) for lubrication.

Clause 16: The fluid turbine-generator (101) of any preceding clause, further comprising a cooling medium inlet (28) extending through the pressure housing (23) and into the entire interior volume (23′), for example, into a generator compartment (23b) of the pressure housing (23).

Clause 17: The fluid turbine-generator (101) of the preceding clause, wherein a cooling medium outlet out of the entire interior volume (23′) is provided via the outlet (12b).

Clause 18: The fluid turbine-generator (101) of any preceding clause, further comprising a cooling medium outlet (29) extending through the pressure housing (23) and out of the entire interior volume (23′), for example, from a generator compartment (23b) of the pressure housing (23).

Clause 19: The fluid turbine-generator (101) of any preceding clause, comprising a bleed-off cooling fluid line (34) fluidly connected to the inlet (12a) and/or to the turbine (20) upstream the low-pressure end (20′) and configured to route a stream of the working fluid to the cooling medium inlet (28), for example, to the generator compartment (23b), via a cooling fluid heat exchanger (35).

Clause 20: The fluid turbine-generator (101) of the preceding clause, comprising a liquid separator (36) arranged downstream of the cooling fluid heat exchanger (35).

Clause 21: The fluid turbine-generator (101) of the preceding clause, wherein the liquid separator (36) is connected to and configured to discharge liquid into or downstream of the outlet (12b) or into the flow loop (12) downstream of the turbine (20).

Clause 22: The fluid turbine-generator (101) of any preceding clause, in which the pressure housing (23) is made up of two parts (23c,23d) having a different size in a plane perpendicular to the longitudinal axis if the shaft (22).

Clause 23: A power plant (100) comprising:
a fluid turbine-generator (101) according to any preceding clause,
a flow loop (12) operatively connected to the inlet (12a) and outlet (12b) and comprising a first heat exchanger (11) configured to heat a working fluid circulating in the flow loop (12), a pump (14), and a second heat exchanger (13) configured to cool the working fluid circulating in the flow loop (12).

Clause 24: The power plant (100) according to any preceding clause, comprising a reactor (10) having a fuel inlet (40a), a reactant inlet (41a), and a flue gas outlet line (42) fluidly connected to the first heat exchanger (11).

Clause 25: The power plant (100) according to any preceding clause, wherein the working fluid is water and the power plant (100) is configured to evaporate the water in the first heat exchanger (11) and to condense the water in the second heat exchanger (13).

Clause 26: The power plant (100) according to any preceding clause, wherein the second heat exchanger (13) comprises a sea water loop for cooling the working fluid.

Clause 27: The power plant (100) according to any preceding clause, wherein the working fluid is or comprises CO₂, such as more than 50%, more than 70%, or more than 90% CO₂.

Clause 28: The power plant (100) according to any preceding clause, wherein the power plant (100) is configured to operate with the CO₂ in a supercritical state in the entire cycle.

Clause 29: The power plant (100) according to any preceding clause, wherein the CO₂ downstream of the turbine (20) is condensed to liquid or to a partially liquid state.

Clause 30: The power plant (100) according to any preceding clause, wherein the pump (14) is a liquid pump, a multiphase pump, a fan, or a compressor.

Clause 31: The power plant (100) according to any preceding clause, wherein the power plant (100) is configured to operate with a pressure at the outlet (12b) which is less than 1 bara, less than 0.5 bara, or less than 0.2 bara.

Clause 32: The power plant (100) according to any preceding clause, wherein the power plant (100) is configured to operate with a pressure at the outlet (12b) which is higher than 5 bara, higher than 10 bara, or higher than 25 bara.

Clause 33: The power plant (100) according to any preceding clause, wherein the turbine-generator (101) is arranged subsea, or wherein the power plant (100) is arranged subsea.

Clause 34: The power plant (100) according to any preceding clause, further comprising a cooling and/or lubrication medium supply pipe (30) extending from the flow loop (12) downstream of the second heat exchanger (13), in particular wherein the cooling and/or lubrication medium pipe (30) extends from the flow loop (12) downstream of the pump (14), and into the pressure housing (23) via the cooling medium inlet (28) and/or via a lubrication fluid inlet.

Clause 35: The power plant (100) according to any preceding clause, wherein the pressure housing (23) is configured to discharge cooling medium out of the pressure housing (23) and into the flow loop (12) via the outlet (12b) and together with the working fluid.

Clause 36: The power plant (100) according to any preceding clause, further comprising a cooling medium discharge pipe (32) extending from a cooling medium outlet (29) and into the flow loop (12).

Clause 37: The power plant (100) according to any preceding clause, wherein the cooling medium discharge pipe (32) is connected to the flow loop (12) downstream of the turbine (20) and upstream of the pump (14).

Clause 38: The power plant (100) according to any preceding clause, wherein the flue gas outlet line (42) is connected, downstream of the first heat exchanger (11), to a deposit line (46) and a deposit pump (47).

Clause 39: The power plant (100) according to any preceding clause, wherein the deposit line (46) is fluidly connected to an underground formation downstream of the deposit pump (47).

Clause 40: The power plant (100) according to any preceding clause, wherein the deposit pump (47) is a liquid pump, a multiphase pump, or a wet-gas compressor.

Clause 41: The power plant (100) according to any preceding clause, comprising a recycle line (48,50) arranged downstream of the first heat exchanger (11) and arranged to recycle flue gas to the reactor (10).

Clause 42: The power plant (100) according to any preceding clause, comprising a flue gas cooler (43) arranged downstream of the first heat exchanger (11) and wherein the recycle line (48,50) is arranged to recycle flue gas from downstream of the flue gas cooler (43) to the reactor (10).

Clause 43: The power plant (100) according to any preceding clause, wherein the flue gas cooler (43) is a seawater cooler.

Clause 44: The power plant (100) according to any preceding clause, comprising:
a first recycle line (48) operable to recycle flue gas into structural cooling channels in the reactor (10), and
a second recycle line (50) operable to recycle flue gas into a combustion chamber in the reactor (10).

Clause 45: The power plant (100) according to any preceding clause, wherein the first recycle line (48) is arranged to recycle flue gas from downstream of the flue gas cooler (43).

Clause 46: The power plant (100) according to any preceding clause, wherein the second recycle line (50) is arranged to recycle flue gas from upstream of the flue gas cooler (43).

Clause 47: The power plant (100) according to any preceding clause, wherein the fuel inlet (40a) is fluidly connected to a hydrocarbon well (60).

Clause 48: The power plant (100) according to the preceding clause, wherein the fuel inlet (40a) is configured to receive a gaseous hydrocarbon fuel from the hydrocarbon well via a fuel line (40) and at a pressure above 20 bara, above 30 bara, or above 40 bara.

Clause 49: A method of producing electric power, the method comprising:
operating a power plant (100) according to any preceding clause, the power plant (100) arranged on a sea floor (61) or on an offshore platform;
receiving, at the fuel inlet (40a), a carbonaceous fuel extracted from an offshore hydrocarbon well;
providing a reactant at a reactant inlet (41a), the reactant inlet being provided from a land-based location, from the offshore platform, or from a tank arranged at the sea floor (61); and
pumping flue gas from the reactor (10) to an underground formation.

### LIST OF REFERENCE NUMERALS

10 Reactor
11 Heat exchanger/First heat exchanger
12 Flow loop
12a Inlet/Fluid inlet
12b Outlet/Fluid outlet
13 Cooling heat exchanger/Second heat exchanger
14 Pump
14a Motor
20 Turbine
20′ Low-pressure end
21 Electric generator
22 Shaft/Common shaft
22a First shaft part
22b Second shaft part
23 Pressure housing
23a Turbine compartment
23b Generator compartment
23c First part
23d Second part
23′ Interior volume/Entire interior volume
24a Bearing
24b Bearing
24c Bearing
24d Bearing
25 Recuperating heat exchanger
26 Division
26a Seal
27 Location
28 Cooling medium inlet
29 Cooling medium outlet
30 Cooling medium supply pipe/Cooling and/or lubrication medium supply pipe
31 Regulation valve
32 Cooling medium discharge pipe
33 Bleed-off lubrication fluid line
34 bleed-off cooling fluid line
35 Cooling fluid heat exchanger
36 Liquid separator
37 Gear
40 Fuel line
40a Fuel inlet
41 Reactant line
41a Reactant inlet
42 Reactor outlet line/Flue gas outlet line
43 Cooler/Flue gas cooler
44 Line
45 Collection vessel
46 Deposit line
47 Deposit pump
47a Motor
48 First recycle line
49 Pump
49a Motor
50 Second recycle line
51 Pump
51a Motor
60 Hydrocarbon well
61 Sea floor
62 Wellhead
100 Power plant
101 Turbine-generator/Fluid turbine-generator

What is claimed is:

1-28. (canceled)

29. A fluid turbine-generator comprising:
a pressure housing;
a turbine comprising a fluid inlet and a fluid outlet, the fluid inlet being connected to the turbine and being arranged to extend into the pressure housing, and the fluid outlet being connected to the turbine and being arranged to extend out of the pressure housing;
an electric generator; and
a shaft which is configured to mechanically connect the turbine and the electric generator;
wherein,
the turbine and the electric generator are each arranged inside the pressure housing, and
the shaft is arranged completely inside the pressure housing.

30. The fluid turbine-generator as recited in claim 29, further comprising:
a gear,
wherein,
the shaft comprises a first shaft part and a second shaft part,
the first shaft part and the second shaft part are interconnected via the gear, and
the first shaft part, the second shaft part, and the gear are each completely arranged inside the pressure housing.

31. The fluid turbine-generator as recited in claim 29, wherein,
the shaft is provided as a common shaft, and
the turbine and the electric generator are longitudinally spaced along the common shaft.

32. The fluid turbine-generator as recited in claim 29, wherein,
the pressure housing comprises a generator compartment which is configured to be filled with a fluid,
the fluid inlet is configured to supply a fluid to the turbine, and
the fluid the generator compartment is configured to be filled with is the same as the fluid which is as supplied to the turbine via the fluid inlet.

33. The fluid turbine-generator as recited in claim 32, wherein,
the pressure housing has an interior volume and further comprises a division arranged therein, and
the division is configured to separate the interior volume of the pressure housing into a turbine compartment and the generator compartment.

34. The fluid turbine-generator as recited in claim 33, wherein the division comprises a seal which is arranged towards the shaft.

35. The fluid turbine-generator as recited in claim 33, further comprising:
a cooling medium inlet which is arranged to extend through the pressure housing and into the interior volume.

36. The fluid turbine-generator as recited in claim 35, wherein the cooling medium inlet is further arranged to extend into the generator compartment of the pressure housing.

37. The fluid turbine-generator as recited in claim 33, further comprising:
a cooling medium outlet which is arranged to extend out of the interior volume via the fluid outlet.

38. The fluid turbine-generator as recited in claim 33, further comprising:
a cooling medium outlet which is arranged to extend through the pressure housing and out of the interior volume.

39. The fluid turbine-generator as recited in claim 38, wherein the cooling medium outlet is further arranged to extend from the generator compartment of the pressure housing.

40. A power plant comprising:
a fluid turbine-generator comprising,
a pressure housing,
a turbine comprising a fluid inlet and a fluid outlet, the fluid inlet being connected to the turbine and being arranged to extend into the pressure housing, and the fluid outlet being connected to the turbine and being arranged to extend out of the pressure housing, and
an electric generator,
wherein,
the turbine and the electric generator are each arranged inside the pressure housing; and
a flow loop which is operatively connected to the fluid inlet and to the fluid outlet, the flow loop comprising,
a first heat exchanger which is configured to heat a working fluid circulating in the flow loop,
a pump, and
a second heat exchanger which is configured to cool the working fluid circulating in the flow loop.

41. The power plant as recited in claim 40, wherein,
the working fluid is water, and
the power plant is configured to evaporate the water in the first heat exchanger and to condense the water in the second heat exchanger.

42. The power plant as recited in claim 40, wherein the second heat exchanger comprises a sea water loop for cooling the working fluid.

43. The power plant as recited in claim 40, wherein the working fluid is CO₂.

44. The power plant as recited in claim 40, further comprising:
a cooling and/or lubrication medium pipe; and
a cooling medium inlet and/or a lubrication fluid inlet which is/are configured to provide a cooling medium to the pressure housing,
wherein,
the cooling and/or lubrication medium pipe is arranged to extend from the flow loop downstream of the pump and into the pressure housing via the cooling medium inlet and/or via the lubrication fluid inlet.

45. The power plant as recited in claim 44, wherein the pressure housing is configured to discharge the cooling medium out of the pressure housing and into the flow loop via the fluid outlet together with the working fluid.

46. The power plant as recited in claim 40, further comprising:
a deposit line;
a deposit pump; and
a flue gas outlet line which, downstream of the first heat exchanger, is connected to the deposit line and to the deposit pump.

47. The power plant as recited in claim 46, wherein the deposit line is fluidly connected to an underground formation which is downstream of the deposit pump.

48. The power plant as recited in claim 40, further comprising:
a reactor;
a flue gas cooler which is arranged downstream of the first heat exchanger; and
a recycle line which is configured to recycle flue gas from downstream of the flue gas cooler to the reactor.

49. The power plant as recited in claim 48, wherein the flue gas cooler is a seawater cooler.

50. A method of producing electric power, the method comprising:
providing the power plant as recited in claim 29 on a sea floor or on an offshore platform;
operating the power plant on the sea floor or on the offshore platform;
receiving, at a fuel inlet, a carbonaceous fuel which has been extracted from an offshore hydrocarbon well;
providing a reactant at a reactant inlet, the reactant being provided from a land-based location, from the offshore platform, or from a tank arranged on the sea floor; and
pumping a flue gas from the reactor to an underground formation.
